(19) United States
(12) Patent Application Publication
(10) Pub. No.: US 2006/0126118 A1
(43) Pub. Date: Jun. 15, 2006

(54) Print control method, print control apparatus, and computer product

(75) Inventor: Masaharu Nagata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/352,261

(22) Filed: Feb. 13, 2006

Related U.S. Application Data
(63) Continuation of application No. PCT/JP03/10304, filed on Aug. 13, 2003.

(51) Int. Cl. G06F 3/12

(52) U.S. Cl. 358/1.15

(57) ABSTRACT

Printing in a printing system including a plurality of printers shared by a plurality of hosts is controlled. An inquiry is sent to each of the printers inquiring a status of the printers in response to a print request from one of the hosts. A printer is selected among printers that responded to the inquiry. The printer that responded first to the inquiry can be selected, for example. The selected printer is controlled to perform printing.

### BACKGROUND OF THE INVENTION

1. Field of the Invention

The present invention relates to a technology for reducing time required for printing and distributing load among printers.

2. Description of the Related Art

FIG. 16 is a block diagram of a conventional printing system. Printers 1₁ to 1₃ receive print requests from hosts 3₁ to 3₃ via a local area network (LAN) 2, and print printing data onto a recording medium, such as paper, in response to the print requests. The hosts 3₁ to 3₃ are, for example, personal computer terminals that send print requests to any one of the printers 1₁ to 1₃. Thus, the printers 1₁ to 1₃ are shared by the hosts 3₁ to 3₃ through the LAN 2.

For example, when the host 3₁ sends a print request to the printer 1₁, the printer 1₁ performs a print processing. Japanese Patent Application Laid Open Nos. 2002-49479 and 7-121322 disclose related technology.

However, if the printer 11 receives a print request from the host 3₂ while it is performing a print processing for the host 3₁, the printer 1₁ stacks the print request in a queue until it completes the print processing for the host 3₁. If the printer 1₁ receives next print request, this time from the host 3₃, the printer 1₁ stacks the print request in the queue until it completes all the previous print processing.

When a plurality of printing requests are sent at substantially the same time from the hosts 3₁ to 3₃ to one printer, for example the printer 1₁, a load on the printer 1₁ increases, and completion of a current print processing is waited for. Accordingly, much time is required from when a print request is sent until a print processing is completed.

Thus, there is a need to develop a technology for reducing time required for printing and to distribute printing load when a plurality of computer terminals share a plurality of printers.

### SUMMARY OF THE INVENTION

It is an object of the present invention to at least solve the problems in the conventional technology.

According to an aspect of the present invention, a method of controlling printing in a printing system including a plurality of printers shared by a plurality of hosts, includes sending an inquiry to each of the printers inquiring a status of the printers in response to a print request from one of the hosts; selecting a printer among printers that responded to the inquiry; and controlling selected printer to perform printing.

According to another aspect of the present invention, an apparatus for controlling printing in a printing system including a plurality of printers shared by a plurality of hosts, includes an inquiring unit that sends an inquiry to each of the printers inquiring a status of the printers in response to a print request from one of the hosts; a selecting unit that selects a printer among printers that responded to the inquiry; and a controlling unit that causes selected printer to perform printing.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a printing system according to an embodiment of the present invention;

FIG. 2 depicts a response management table shown in FIG. 1;

FIG. 3 is a schematic for explaining a print request processing (broadcast method) according to the embodiment;

FIG. 4 is a schematic for explaining a response processing (broadcast method) according to the embodiment;

FIG. 5 is a schematic for explaining a print start processing according to the embodiment;

FIG. 6 is a schematic for explaining a print processing according to the embodiment;

FIG. 7 is a schematic for explaining a print completion processing according to the embodiment;

FIG. 8 is a schematic for explaining a host name search processing according to the embodiment;

FIG. 9 is a schematic for explaining a print request processing (multicast method) according to the embodiment;

FIG. 10 is a schematic for explaining a response processing (multicast method) according to the embodiment;

FIGS. 11 and 12 depict a regular operation according to the embodiment;

FIG. 13 is a schematic for explaining an operation according to the embodiment when a recoverable failure occurs;

FIG. 14 is a schematic for explaining an operation according to the embodiment when an irrecoverable failure occurs;

FIG. 15 is a block diagram of a modification of the embodiment; and

FIG. 16 is a block diagram of a conventional printing system.

### DETAILED DESCRIPTION OF THE PREFERRED EMBODIMENTS

Exemplary embodiments of the present invention will be described below with reference to accompanying drawings. The present invention is not limited to these embodiments.

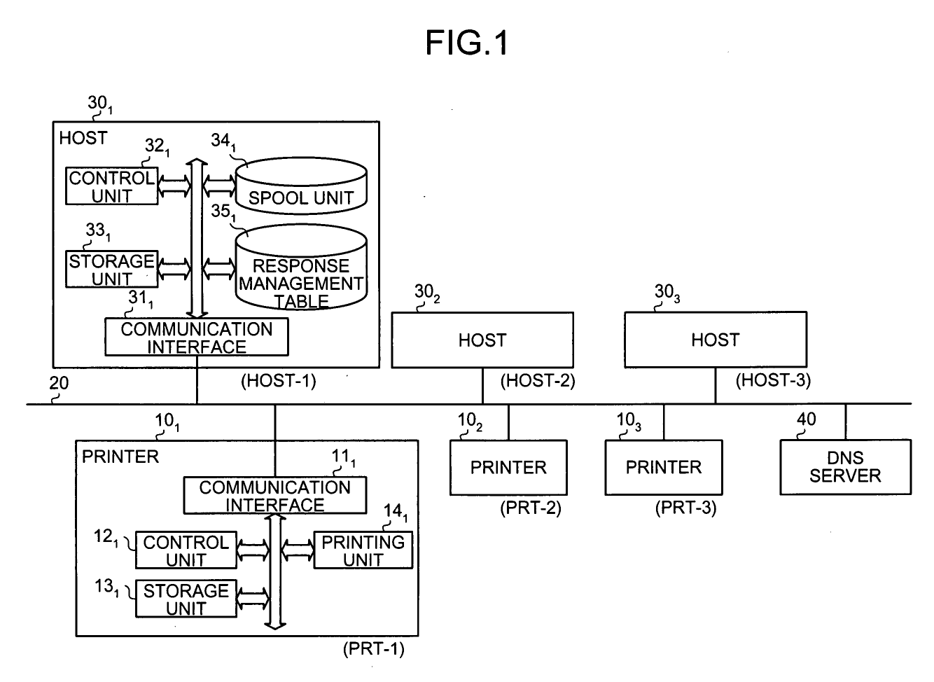

FIG. 1 is a block diagram of a printing system according to an embodiment of the present invention. The printing system includes printers 10₁ to 10₃, a LAN 20, hosts 30₁ to 30₃, and a domain name system (DNS) server 40.

The printers 10₁ to 10₃ receive print requests from the hosts 30₁ to 30₃ via the LAN 20, and print printing data onto a recording medium, such as paper, in response to the print requests. Thus, the printers 10₁ to 10₃ are shared by the hosts 30₁ to 30₃.

In the printer 10₁, a communication interface 11₁ controls communication according to a predetermined communication protocol. A control unit 12₁ controls print processings. A storage unit 13₁ stores data such as printing data. A printing unit 14₁ is controlled by the control unit 12₁ to print printing data onto the recording medium.

The printer 10₂ and the printer 10₃ have the same configuration as the printer 10₁, therefore, their explanation will be omitted

The hosts 30₁ to 30₃ are, for example, personal computer terminals. Each host sends a print request to any one of the printers 10₁ to 10₃. In the host 30₁, a communication interface 31₁ controls communication according to a predetermined communication protocol. A control unit 32₁ controls processings such as print processings. A storage unit 33₁ stores a computer program and data such as printing data.

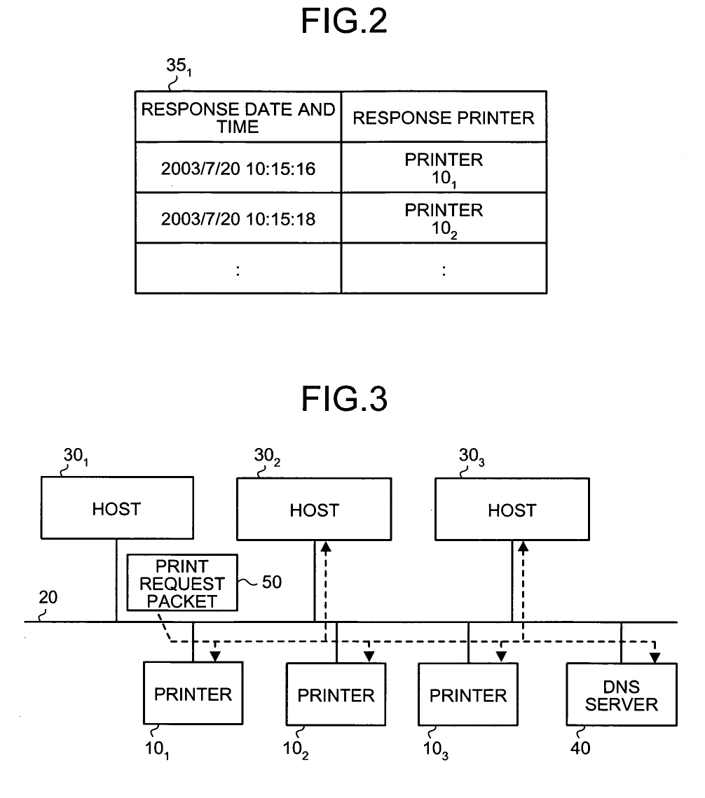

A spool unit 34₁ accumulates printing data. A response management table 35₁ manages response statuses from the printers 10₁ to 10₃ when the host 30₁ sends a print request to any of the printers 10₁ to 10₃. As shown in FIG. 2, the response management table 35₁ includes fields of response date and time and response printer. The response date and time is when a printer responds to a print request. The response printer represents the printer that responded to the print request.

The host 30₂ and the host 30₃ have the same configuration as the host 30₁, therefore, their explanation will be omitted. The printers 10₁ to 10₃, the hosts 30₁ to 30₃, and the DNS server 40 are each given a unique network address representing a position in the LAN 20.

The printers 10₁ to 10₃ and the hosts 30₁ to 30₃ are each given a host name. The printers 10₁ to 10₃ have host names PRT-1 to PRT-3, and hosts 30₁ to 30₃ have host names HOST-1 to HOST-3. Each host name is paired with a network address and managed by the DNS server 40. The host names are expressed by alphabetical letters to be easily understood by a human being.

The DNS server 40 manages a host name and a network address of each unit, and provides domain name system services such as searching a network address from a host name or searching a host name form a network address.

Operations of the printing system according to the embodiment are described with reference to FIGS. 3 to 10. In a following example, a print request is generated in the host 30₁ and the printer 10₁ performs a print processing.

FIG. 3 is a schematic for explaining a print request processing. When a print request is generated in the host 30₁, the host 30₁ simultaneously sends, by a broadcast method, a print request packet 50 to all the units connected to the LAN 20, i.e., the printers 10₁ to 10₃, the host 30₂ and the host 30₃, and the DNS server 40.

All the units receive the print request packet 50. However, only the printers 10₁ to 10₃ analyze the print request packet 50, and the host 30₂, the host 30₃, and the DNS server 40 discard the print request packet 50.

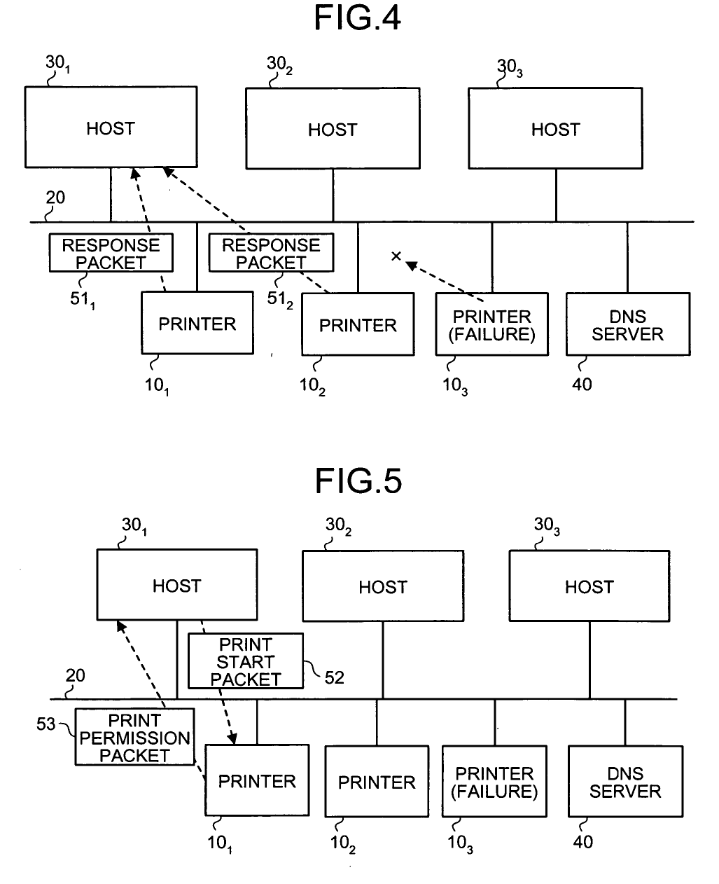

FIG. 4 is a schematic for explaining a response processing. When the printer 10₁ and the printer 10₂ are in a state to start printing when the print request packet 50 is received, the printer 10₁ and the printer 10₂ sends to the host 30₁ a response packet 51₁ and a response packet 51₂, respectively. When the printer 10₃ is not in a state to start printing (failure state), the printer 10₃ does not send a response packet to the host 30₁, and switches to a non-response state.

When the host 30₁ receives the response packet 51₁ and the response packet 51₂, the host 30₁ refers to response statuses in the response management table 35₁, and chooses a printer that responded earlier, for example the printer 10₁.

FIG. 5 is a schematic for explaining a print start processing. The host 30₁ sends a print start packet 52 to the printer 10₁. When the print start packet 52 is received, the printer 10₁ sends a print permission packet 53 to the host 30₁. When the host 30₁ receives the print permission packet 53, a print processing is performed.

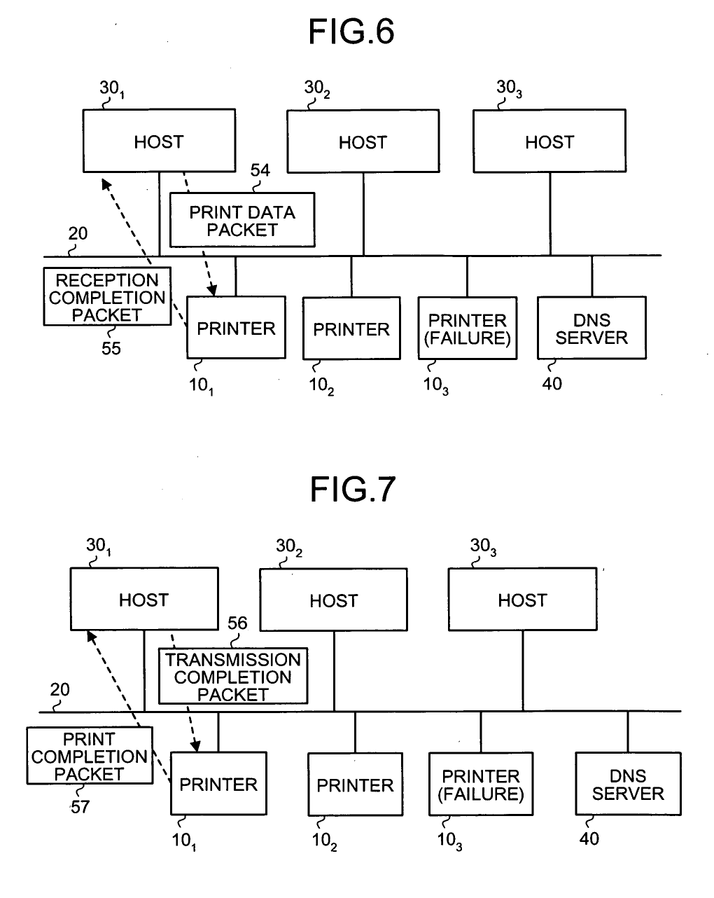

FIG. 6 is a schematic for explaining the print processing. The host 30₁ sends a print data packet 54 to the printer 10₁. When the print data packet 54 is received, the printer 10₁ sends a reception completion packet 55 to the host 30₁, and prints printing data on paper based on the print data packet 54. The printing operation continues as the print data packet 54 and the reception completion packet 55 are repeatedly sent and received.

FIG. 7 is a schematic for explaining a print completion processing. When the last print data packet 54 is sent, the host 30₁ sends a transmission completion packet 56 to the printer 10₁. When the transmission completion packet 56 is received and the printing is completed, the printer 10₁ sends a print completion packet 57 to the host 30₁.

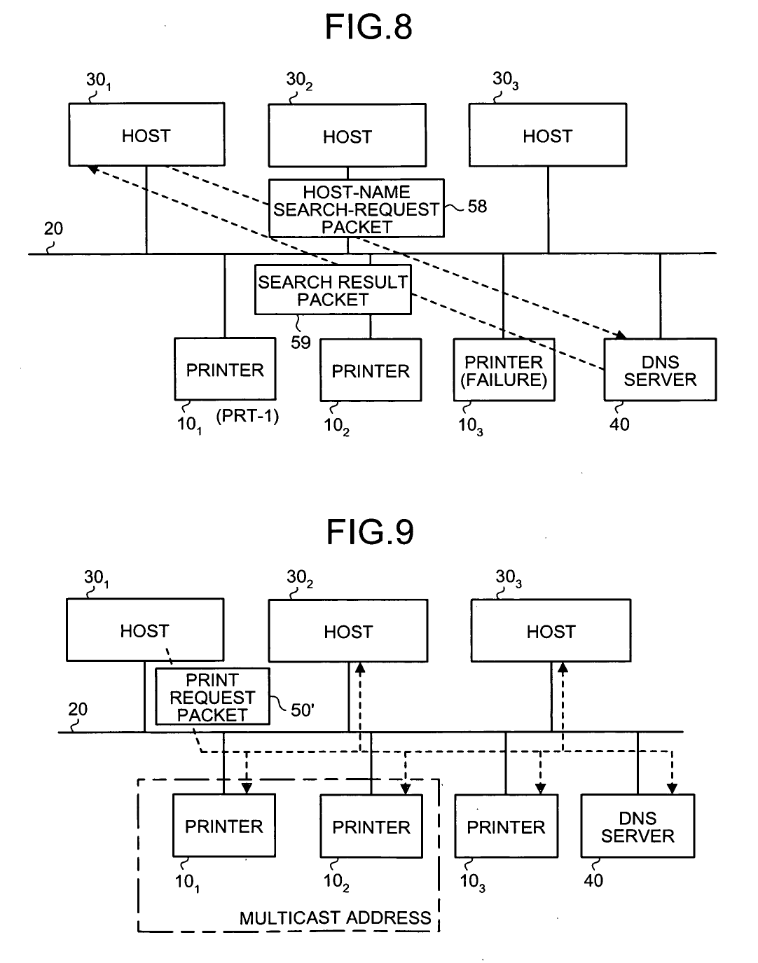

FIG. 8 is a schematic for explaining a host name search processing. When the print completion packet 57 is received, the host 30₁ sends, to the DNS server 40, a host-name search-request packet 58 for searching a host name (PRT-1) of the printer 10₁.

When the host-name search-request packet 58 is received, the DNS server 40 searches the host name (PRT-1) of the printer 10₁ with a network address of the printer 10₁ included in the host-name search-request packet 58 as a search key. The DNS server 40 sends to the host 30₁ the search result packet 59 to notify a search result (PRT-1).

When the search result packet 59 is received, the host 30₁ informs an operator that the printing operation in the PRT-1 (the printer 10₁) is completed by displaying a message on a display unit (not shown), for example.

The print request packet 50 is sent by the broadcast method as described with reference to FIG. 3. However, a print request packet 50′ can be sent by a multicast method (to a multicast address) to the printer 10₁ and the printer 10₂, as shown in FIG. 9.

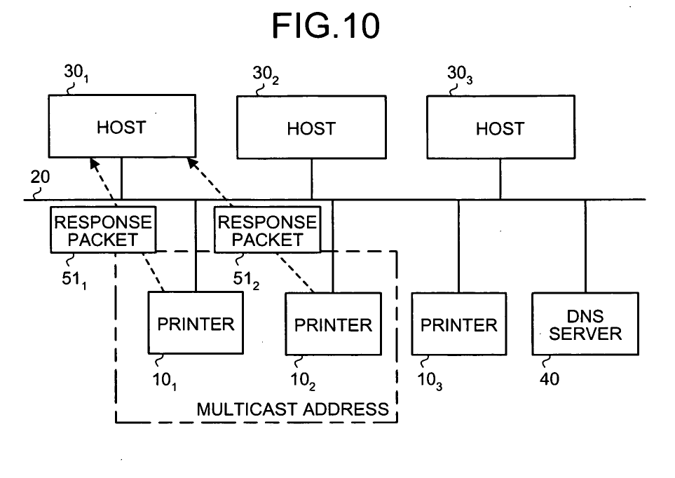

As shown in FIG. 10, in the multicast method, the printer 10₁ and the printer 10₂ sends to the host 30₁ the response packet 51₁ and the response packet 51₂, respectively.

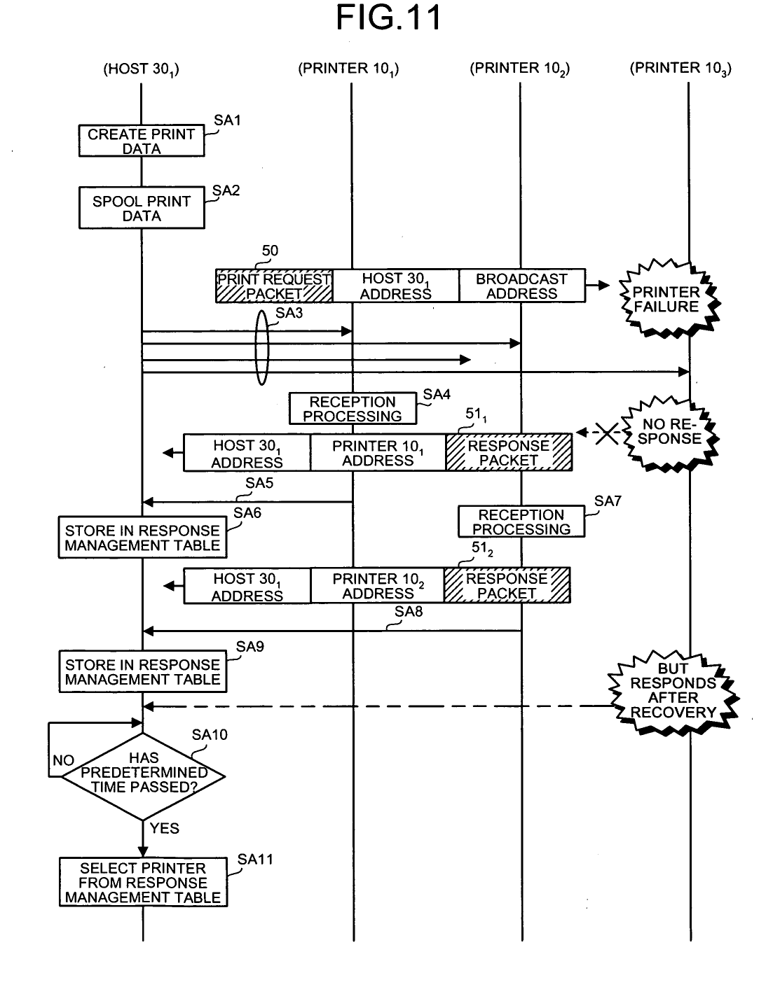

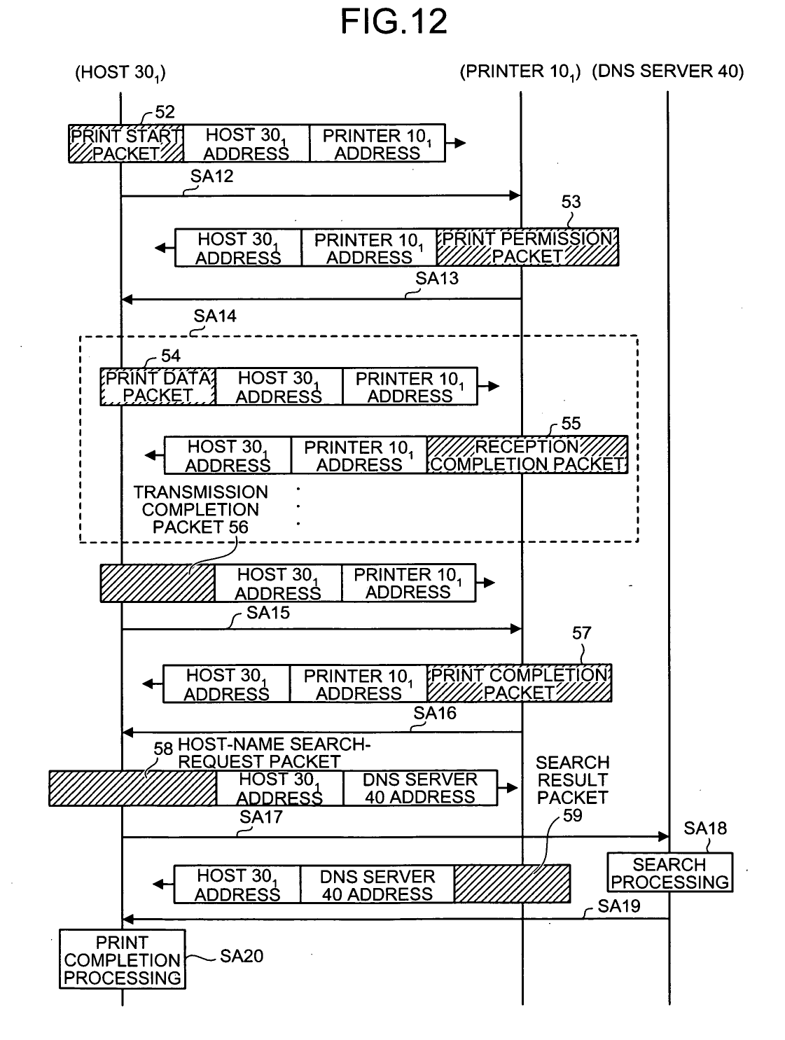

The operations according to the embodiment are described in detail with reference to FIGS. 11 to 14. FIGS. 11 and 12 depict a regular operation (when a failure does not occur). In a following example, a print request is generated in the host 30, and the printer 10, performs a print processing.

When a print request is generated in the host 30₁, at step SA1 shown in FIG. 11, the control unit 32₁ of the host 30₁ (hereinafter, simply the host 30₁) creates printing data. At step SA2, the host 30₁ spools the printing data to the spool unit 34₁.

At step SA3, the host 30₁ simultaneously sends, by the broadcast method, the print request packet 50 that requests a print operation to all units connected to the LAN 20 (the printers 10₁ to 10₃, the host 30₂ and the host 30₃, and the DNS server 40). The print request packet 50 includes a broadcast address (destination) and a network address of the host 30, (source). The broadcast address represents all units connected to the LAN 20.

At step SA4, the printer 10₁ receives the print request packet 50. When the printer 10₁ is able to print, at step SA5, the printer 10₁ sends to the host 30₁ the response packet 51₁ that indicates that the print request packet 50 has been received. The response packet 51₁ includes the network address of the host 30₁ (destination) and a network address of the printer 10₁ (source).

At step SA6, when the response packet 51₁ that indicates that the print request packet 50 has been received is received, the host 30₁ stores in the response management table 35₁, a response date and time in the response packet 51₁ (2003/7/20 10:15:16) and information of the printer that responded (the printer 10₁) (see FIG. 2).

At step SA7, the printer 10₂ receives the print request packet 50 as well. When the printer 10₂ is able to print, at step SA8, the printer 10₂ sends to the host 30₁ the response packet 51₂. The response packet 512 includes the network address of the host 30₁ (destination) and a network address of the printer 10₂ (source).

At step SA9, when the response-packet 51₂ is received, the host 30₂ stores in the response management table 35₁, a response date and time in the response packet 51₂ (2003/7/20 10:15:18) and information of the printer that responded (the printer 10₂). At step SA10, the host 30₁ determines whether a predetermined time has passed since the print request packet 50 was broadcasted at step SA3. In this example, the determination result is No.

When a failure occurs in the printer 10₃, the printer 10₃ cannot send a response packet in response to the print request packet 50 to the host 30₁, and it is therefore regarded that there is no response.

However, if the printer 10₃ recovers while the determination result at step SA10 is No, the printer 10₃ sends a response packet to the host 30₁. When the host 30₁ receives the response packet, the response date and time and information on the printer that responded is stored in the response management table 35₁.

When the predetermined time passes, a determination result of the host 30₁ at step SA10 is Yes. At step SA11, the host 30₁ chooses from the response management table 35₁ a printer that responded earliest as the printer to perform the printing operation. In this example, the printer 10₁ is chosen.

The embodiment can be configured to obtain, from a response packet, information representing a load status (load rate, high load, low load, etc.) of printers that responded, and choose the printer with the lowest load.

At step SA12 shown in FIG. 12, the host 30₁ sends the print start packet 52 that starts a print processing to the printer 10₁. The print start packet 52 includes the network address of the printer 10₁ (destination) and the network address of the host 30₁ (source).

At step SA13, when the print start packet 52 is received, the printer 10₁ sends to the host 30₁ the print permission packet 53 indicating that printing is permitted. The print permission packet 53 includes the network address of the host 30₁ (destination) and the network address of the printer 10₁ (source).

At step SA14, the printing operation is performed as the print data packet 54 and the reception completion packet 55 are repeatedly sent and received between the host 30₁ and the printer 10₁. The print data packet 54 includes the network address of the printer 10₁ (destination), the network address of the host 30₁ (source), and printing data.

The reception completion packet 55 indicates that reception of the print data packet 54 is completed. The reception completion packet 55 includes the network address of the host 30₁ (destination) and the network address of the printer 10₁ (source).

When the last print data packet 54 is sent, at step SA15, the host 30₁ sends to the printer 10₁ the transmission completion packet 56 that indicates that the last print data packet 54 is sent is completed. The transmission completion packet 56 includes the network address of the printer 10₁ (destination) and the network address of the host 30₁ (source).

When the transmission completion packet 56 is received, at step SA16, the printer 10₁ sends to the host 30₁ the print completion packet 57 that indicates that the printing operation is completed. The transmission completion packet 56 includes the network address of the host 30₁ (destination) and the network address of the printer 10₁ (source).

When the print completion packet 57 is received, at step SA17, the host 30₁ sends to the DNS server 40, the host-name search-request packet 58 for searching a host name of the printer 10₁.

The host-name search-request packet 58 includes a network address of the DNS server 40 (destination), the network address of the host 30₁ (source), and the network address of the printer 10₁ (search key).

When the host-name search-request packet 58 is received, at step SA18, the DNS server 40 searches the host name (PRT-1) of the printer 10₁ with the network address of the printer 10₁ included in the host-name search-request packet 58 as a search key.

At step SA19, the DNS server 40 sends to the host 30₁ a search result packet 59 for notifying a search result (PRT-1). The search result packet 59 includes the network address of the host 30₁ (destination), the network address of the DNS server 40 (source), and the search result (PRT-1).

When the search result packet 59 is received, at step SA20, the host 30₁ informs an operator that the printing operation in the PRT-1 (the printer 10₁) is completed by displaying a message on the display unit.

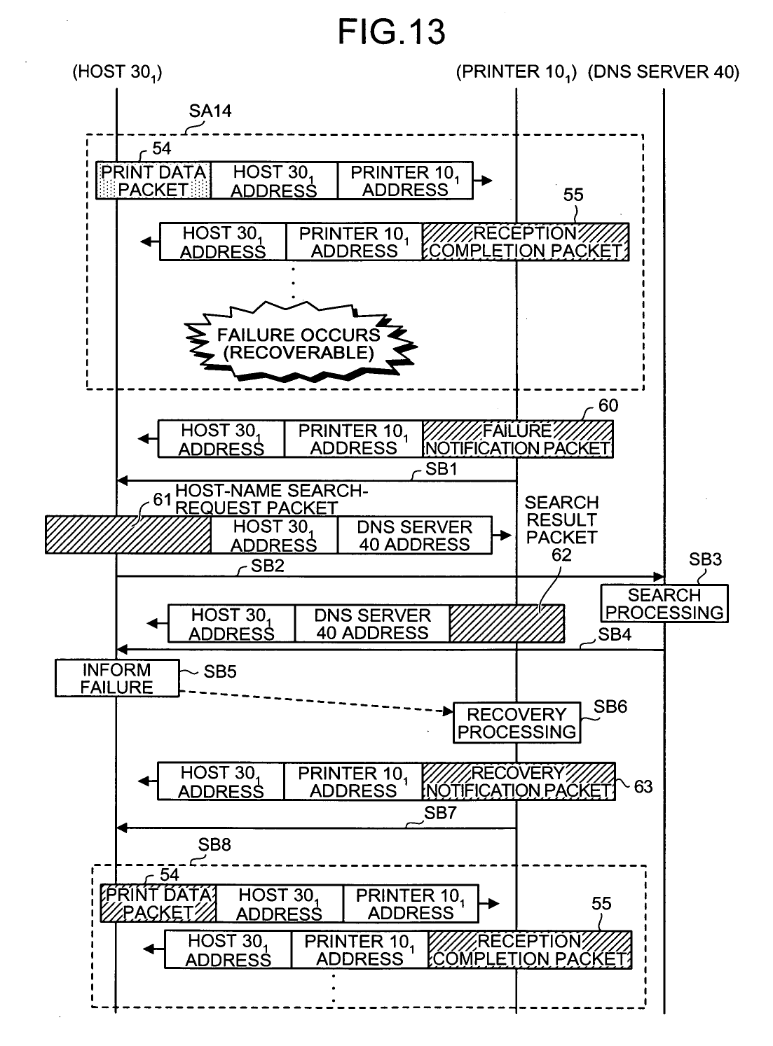

FIG. 13 is a schematic for explaining an operation performed when printing is interrupted during the print processing at step SA14 shown in FIG. 12 due to a recoverable failure (paper jam or paper out, etc.) in the printer 10₁. The recoverable failure refers to a failure that can be recovered without restoring power to a printer.

When a recoverable failure occurs during the print processing at step SA14, at step SB1, the printer 10₁ sends to the host 30₁ a failure notification packet 60 for notifying the recoverable failure.

The failure notification packet 60 includes the network address of the host 30₁ (destination) and the network address of the printer 10₁ (source).

When the failure notification packet 60 is received, at step SB2, the host 30₁ sends, to the DNS server 40, a host-name search-request packet 61 for searching a host name (PRT-1) of the printer 10₁.

The host-name search-request packet 61 includes a network address of the DNS server 40 (destination), the network address of the host 30₁ (source), and the network address of the printer 10₁ (search key).

When the host-name search-request packet 61 is received, at step SB3, the DNS server 40 searches the host name (PRT-1) of the printer 10₁ with the network address of the printer 10₁ included in the host-name search-request packet 61 as a search key.

At step SB4, the DNS server 40 sends to the host 30₁ a search result packet 62 for notifying a search result (PRT-1). The search result packet 62 includes the network address of the host 30₁ (destination), the network address of the DNS server 40 (source), and the search result (PRT-1).

When the search result packet 62 is received, at step SB5, the host 30₁ informs an operator that the recoverable failure occurred in the PRT-1 (the printer 10₁) by displaying a message on the display unit.

Accordingly, at step SB6, the operator recovers the failure by removing a paper jam, for example. At step SB7, the printer 10₁ sends, to the host 30₁, a recovery notification packet 63 for notifying that the failure recovered.

The recovery notification packet 63 includes the network address of the host 30₁ (destination) and the network address of the printer 10₁ (source). At step SB8, the print processing interrupted at step SA14 resumes, and the print data packet 54 and the reception completion packet 55 are repeatedly sent and received.

Subsequently, the steps SA15 to SA20 shown in FIG. 12 are performed.

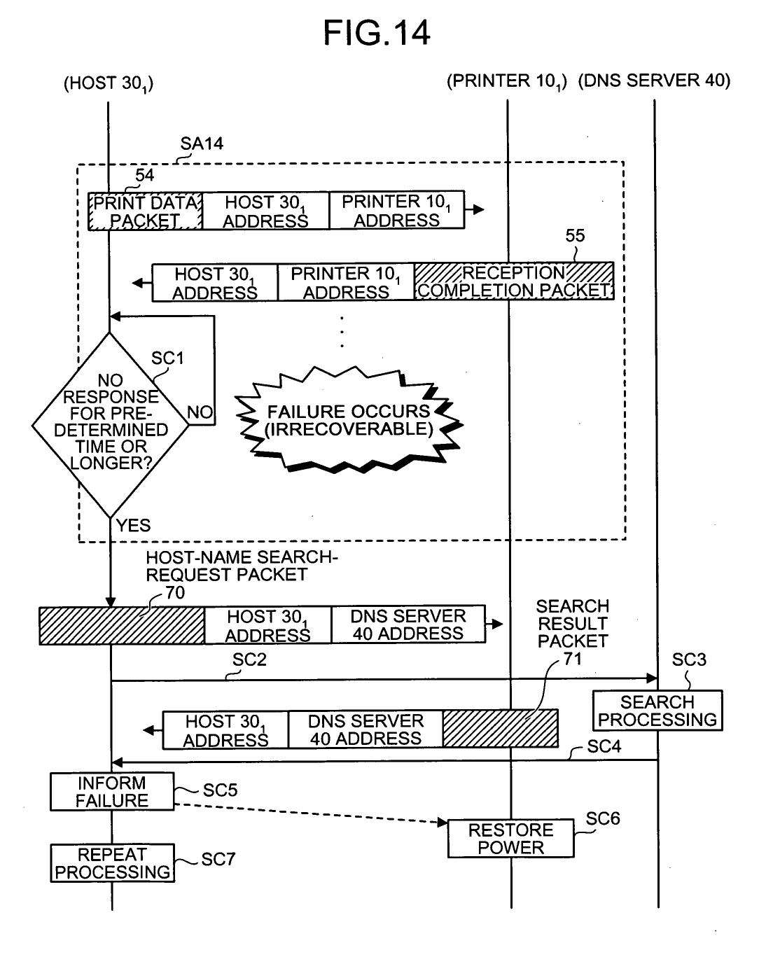

FIG. 14 is a schematic for explaining an operation performed when printing is interrupted during the print processing at step SA14 shown in FIG. 12 due to an irrecoverable failure (no response due to hang up, etc.) in the printer 10₁. The recoverable failure refers to a failure that cannot be recovered unless power is restored to a printer.

During the print processing at step SA14, at step SC1, the host 30₁ determines whether the printer 10₁ does not respond for a predetermined time or longer. When the printer 10₁ responds within the predetermined time, a determination result is No.

When the printer 10₁ hangs up and an irrecoverable failure occurs, and the printer 10₁ does not respond for a predetermined time or longer, the host 30₁ determines that a determination result at step SC1 is Yes.

At step SC2, the host 30₁ sends, to the DNS server 40, a host-name search-request packet 70 for searching a host name (PRT-1) of the printer 10₁.

The host-name search-request packet 70 includes a network address of the DNS server 40 (destination), a network address of the host 30₁ (source), and a network address of the printer 10₁ (search key).

When the host-name search-request packet 70 is received, at step SC3, the DNS server 40 searches the host name (PRT-1) of the printer 10₁ with the network address of the printer 10₁ included in the host-name search-request packet 70 as a search key.

At step SC4, the DNS server 40 sends to the host 30₁ a search result packet 71 for notifying a search result (PRT-1). The search result packet 71 includes the network address of the host 30₁ (destination), the network address of the DNS server 40 (source), and the search result (PRT-1).

When the search result packet 71 is received, at step SC5, the host 30₁ informs an operator that the irrecoverable failure occurred in the PRT-1 (the printer 10₁) by displaying a message on the display unit.

Accordingly, at step SC6, the operator restores power to the printer 10₁ so that the printer 10₁ is forcibly recovered.

At step SC7, the host 30₁ repeats the processings from step SA1 shown in FIG. 11, to start over the printing operation.

According to the embodiment, in response to a print request from the host 30₁ among the hosts 30₁ to 30₃, the printing system inquires a printer status (whether able to print) of each of a plurality of the printers 10₁ to 10₃, selects the printer 10₁ among the printers that responded, and causes the printer 10₁ to perform a printing operation. Thus, when the plurality of printers 10₁ to 10₃ are shared by a plurality of the hosts 30₁ to 30₃, time required for printing can be reduced and load on the printers can be distributed.

Furthermore, the printer that responded earliest can be selected, so that time required for printing can be further reduced.

Moreover, the printer status can be load on each of the printers 10₁ to 10₃, and the printer with the lowest load can be selected, so that load on the printers can be further distributed.

Furthermore, when a printing operation is interrupted due to a failure, the failure is informed to an operator, and the printing operation resumes after the failure is recovered, so that the printing operation can resume quickly after a failure occurs.

Moreover, printer statuses of the plurality of printers 10₁ to 10₃ are inquired simultaneously by the broadcast method (see FIGS. 3 and 4), so that when the plurality of the printers 10₁ to 10₃ are shared by the plurality of hosts 30₁ to 30₃, time required for printing can be reduced and load on the printers can be distributed.

Furthermore, printer statuses of the printer 10₁ and the printer 10₂, which belong to the same group among the plurality of printers 10₁ to 10₃, are inquired by the multicast method (see FIGS. 9 and 10), so that time required for printing can be reduced and load on the printers can be distributed among the printer 10₁ and the printer 10₂.

Moreover, a printer that responded within a predetermined time (see step SA10 in FIG. 11) can be selected as the printer to perform the printing operation (e.g. the printer 10₁). Thus, many responses can be received within the predetermined time.

The present invention is not limited by the embodiment, and various modifications can be made without departing from the spirits of the present invention.

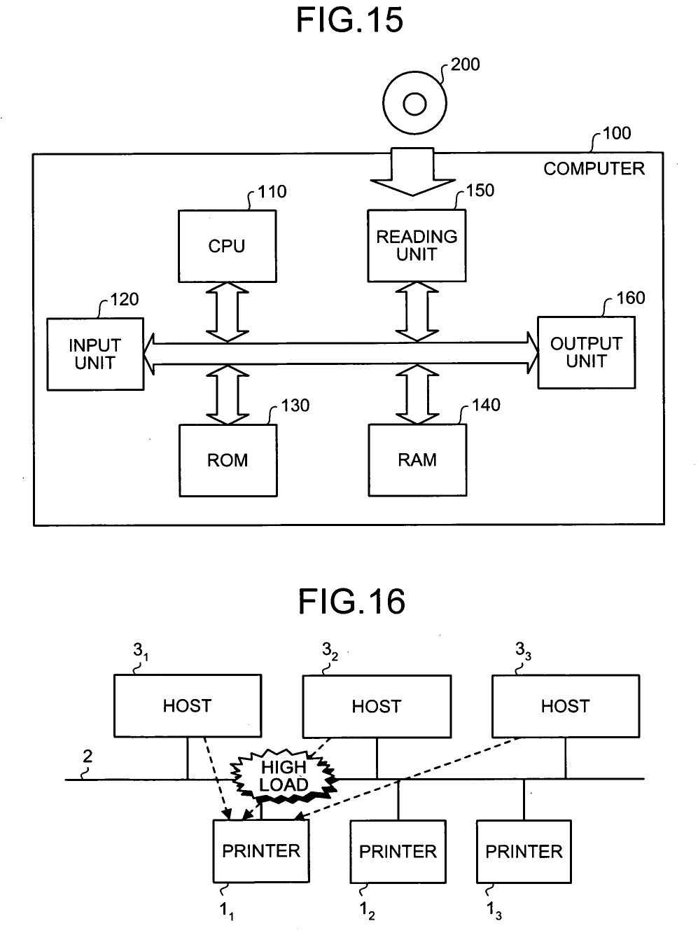

For example, a program for realizing various functions of the printers 10₁ to 10₃, the hosts 30₁ to 30₃, and the DNS server 40 can be recorded in a computer-readable recording medium 200 shown in FIG. 15. A computer 100 can read and execute the program to realize the functions.

The computer 100 includes a central processing unit (CPU) 110 that executes the program, an input unit 120 such as a keyboard and a mouse, a read only memory (ROM) 130 that stores various data, a random access memory (RAM) 140 that stores calculation parameters, a reading unit 150 that reads the program from the recording medium 200, and an output unit 160 such as a display screen and a printer.

The CPU 110 reads the program recorded in the recording medium 200 via the reading unit 150, and executes the program to realize the functions. The recording medium 200 can be an optical disk, a flexible disk, and a hard disk, etc.

According to an aspect of the present invention, when a plurality of the printers are shared by a plurality of hosts, time required for printing can be reduced and load on the printers can be distributed.

Furthermore, a printing operation can resume quickly after a failure occurs.

Moreover, time required for printing can be reduced and load on printers can be distributed among a plurality of printers belonging to the same group.

Furthermore, many responses can be received from printers within a predetermined time.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of controlling printing in a printing system including a plurality of printers shared by a plurality of hosts, the method comprising:
sending an inquiry to each of the printers inquiring a status of the printers in response to a print request from one of the hosts;
selecting a printer among printers that responded to the inquiry; and
controlling selected printer to perform printing.

2. The method according to claim 1, wherein
the status corresponds to a state of being able to perform printing, and
the selecting includes selecting a printer that responded earliest to the inquiry.

3. The method according to claim 1, wherein
the status corresponds to work load on a corresponding printer, and
the selecting includes selecting a printer with a lowest working load.

4. The method according to claim 1, further comprising:
informing, when the printing is interrupted by a failure in the selected printer, that the failure occurred; and
resuming the printing after the selected printer recovers from the failure.

5. The method according to claim 1, wherein
the sending includes simultaneously sending the inquiry to all of the printers by a broadcast method.

6. The method according to claim 1, wherein
the sending includes sending the inquiry to printers belonging to a same group among the printers by a multicast method.

7. The method according to claim 1, wherein
the selecting includes selecting a printer that responded within a predetermined time counted from a time point that starts with sending of the inquiry.

8. The method according to claim 1, wherein
the printing system includes a plurality of printers.

9. An apparatus for controlling printing in a printing system including a plurality of printers shared by a plurality of hosts, the apparatus comprising:
an inquiring unit that sends an inquiry to each of the printers inquiring a status of the printers in response to a print request from one of the hosts;
a selecting unit that selects a printer among printers that responded to the inquiry; and
a controlling unit that causes selected printer to perform printing.

10. The apparatus according to claim 9, wherein
the status corresponds to a state of being able to perform printing, and
the selecting unit selects a printer that responded earliest to the inquiry.

11. The apparatus according to claim 9, wherein
the status corresponds to work load on a corresponding printer, and
the selecting unit selects a printer with a lowest working load.

12. The apparatus according to claim 9, further comprising:
an informing unit that informs, when the printing is interrupted by a failure in the selected printer, that the failure occurred; and
a resuming unit that resumes the printing after the selected printer recovers from the failure.

13. The apparatus according to claim 9, wherein
the inquiring unit simultaneously sends the inquiry to all of the printers by a broadcast method.

14. The apparatus according to claim 9, wherein
the inquiring unit sends the inquiry to printers belonging to a same group among the printers by a multicast method.

15. The apparatus according to claim 9, wherein
the selecting unit selects a printer that responded within a predetermined time counted from a time point that starts with sending of the inquiry.

16. The apparatus according to claim 9, wherein
the printing system includes a plurality of printers.

17. A computer-readable recording medium that stores therein a computer program that implements on a computer a method of controlling printing in a printing system including a plurality of printers shared by a plurality of hosts, the computer program causing the computer to execute:
sending an inquiry to each of the printers inquiring a status of the printers in response to a print request from one of the hosts;
selecting a printer among printers that responded to the inquiry; and
controlling selected printer to perform printing.

18. The computer-readable recording medium according to claim 17, wherein
the status corresponds to a state of being able to perform printing, and
the selecting includes selecting a printer that responded earliest to the inquiry.

19. The computer-readable recording medium according to claim 17, wherein
the status corresponds to work load on a corresponding printer, and
the selecting includes selecting a printer with a lowest working load.

20. The computer-readable recording medium according to claim 17, further causing the computer to execute:
informing, when the printing is interrupted by a failure in the selected printer, that the failure occurred; and
resuming the printing after the selected printer recovers from the failure.
